(19) United States
(12) Patent Application Publication
(10) Pub. No.: US 2018/0257727 A1
(43) Pub. Date: Sep. 13, 2018

(54) FOLDABLE THREE-WHEELED SCOOTER

(71) Applicant: Jin YE, Beijing (CN)

(72) Inventor: Jin YE, Beijing (CN)

(21) Appl. No.: 15/684,950

(22) Filed: Aug. 24, 2017

(30) Foreign Application Priority Data
Mar. 13, 2017 (CN) 201720237117.0
Jul. 14, 2017 (CN) 201720856164.3

(51) Int. Cl. B62K 3/00; B62K 15/00

(52) U.S. Cl. CPC B62K 3/002; A63C 17/011; B62K 15/006

(57) ABSTRACT

The present application discloses a foldable three-wheeled scooter, including a front fork and a frame. A handle bar is provided at the upper end of the front fork, a front wheel is connected to lower end of the front fork by front wheel bracket, and a saddle is provided on the frame. A vertical first groove is provided at the front end of the frame, a horizontal second groove is provided at two sides of the frame, the front fork is embedded into the first groove and is movably connected to the frame by first pin shaft. The front fork is embedded into a first groove and is movably connected to the frame by a first pin shaft. A first folding mechanism is provided in the middle of the front fork.

### CROSS REFERENCE TO RELATED APPLICATIONS

This application claims priority to a Chinese patent application No. 201720237117.0, filed on Mar. 13, 2017, and a Chinese patent application No. 201720856164.3, filed on Jul. 14, 2017, the entire contents of which are incorporated herein by reference.

### TECHNICAL FIELD

The present application relates to the field of three-wheeled vehicles, in particular, to a foldable three-wheeled scooter.

### BACKGROUND OF THE INVENTION

The three-wheeled scooter is a traditional play toy for children. At present, there are some foldable three-wheeled scooters in the market. However, only the front forks of the current three-wheeled scooters for children are foldable. These foldable three-wheeled scooters still occupy a larger space, so that they cannot be placed in the trunk of a smaller car. Further, the current three-wheeled scooters also occupy a certain space if being placed at home. Hence, it is desirable to have a three-wheeled scooter whose front wheel and rear wheels are all foldable so that it is easily foldable and space-saving. Moreover, it is also necessary to guarantee a stable body structure and a safe and reliable scooting effect.

### SUMMARY OF THE INVENTION

The technical problem needed to be solved in the present application is to provide an easily foldable, compact, safe and reliable three-wheeled scooter.

To achieve the above purpose, a foldable three-wheeled scooter of the present application includes a front fork and a frame. A handle bar is provided at an upper end of the front fork, a front wheel is connected to a lower end of the front fork by a front wheel bracket, and a saddle is provided on the frame. A vertical first groove is provided at a front end of the frame, a horizontal second groove is provided at two sides of the frame, the front fork is embedded into a first groove and is movably connected to the frame by a first pin shaft. A first folding mechanism is provided in middle of the front fork, a rear part of the second groove is connected to one end of a rear wheel bracket by a second folding mechanism, and the other end of the rear wheel bracket is connected to rear wheels.

According to the technical solution, the front fork of the scooter is folded and stored at the bottom of the saddle through the first folding mechanism. The rear wheel brackets are folded and stored on the two sides of the saddle through the second groove which is horizontally provided on the two sides of the frame. This folding mode is convenient to operate, and the front fork and the rear wheel brackets can be smoothly folded, and the occupied space is small after being folded. Thus, the space of the saddle is fully utilized, and the folded structure is compact and easy to carry.

The present application is further arranged as below. The first folding mechanism includes a compression spring and a folding handle successively sleeved on the middle of the front fork, a positioning bump is provided on an upper part of the folding handle and is close to the frame, a groove corresponding to the positioning bump is provided on the frame.

According to the technical solution above, the folding handle of the first folding mechanism is pulled, so that the positioning bump corresponds to the groove in the frame. The folding handle and the positioning bump are fixed through spring so that the scooter can be fixed after being unfolded. When the scooter runs normally, the front fork is firmly locked with the frame without any movement.

The present application is further arranged as below. The second folding mechanism includes a rotation head embedded in the second groove, an axle hole is provided in middle of the rotation head, the rotation head is movably connected to the second groove by a second pin shaft through the axle hole, an axle hole of the second groove and an arc-shaped through hole are provided in a lower part of the second groove, the arc-shaped through hole includes an arc-shaped guide slot, two ends of the guide slot are respectively connected to two limiting holes of the same size, a folding lock hole axially parallel to the axle hole is provided in the rotation head, a convex ring extending inward is provided at a lower end of the folding lock hole, a folding lock pin and a spring are successively provided in the folding lock hole, and the folding lock pin goes through the arc-shaped through hole.

According to the above technical solution, the rear wheel brackets rotate around the second pin shaft to achieve the folding and unfolding of the rear wheel brackets. The locking after folding and the locking after unfolding are respectively realized through the folding lock pin and the arc-shaped through hole. In the folding process, a part of the folding lock pin slides along the through hole in the arc-shaped through hole, to smoothly enable the folding process. The folding actions of the scooter are much safer, and the deviation of the brackets is avoided. After being folded, the rear wheel brackets on the two sides are stored in the space on the two sides of the frame, thus ensuring a compact structure after being folded.

The present application is further arranged as below. In the foldable three-wheeled scooter, the guide slot is concentric with the axle hole of the second groove.

According to the technical solution above, it is ensured that when the rotation head rotates, the folding lock pin always rotates around the second pin shaft, so that the whole folding process is firm and reliable.

The present application is further arranged as below. In the foldable three-wheeled scooter, the folding lock pin includes an unlocking part, a locking part, and a guiding part, which have successively increased diameters.

According to the technical solution above, the folding lock pin can be movably installed in the folding lock hole. The folding lock pin is longitudinally and movably engaged with the folding lock hole through the arrangement of different diameters so that the locking or sliding actions of the scooter in different states can be completed. The device is reasonable and simple in structure, safe and reliable.

The present application is further arranged as below. In the foldable three-wheeled scooter, the guiding part corresponds to the folding lock hole, the locking part corresponds to the limiting holes, and the unlocking part corresponds to the guiding slot.

According to the technical solution above, the guide part of the folding lock pin is always limited in the folding lock hole when sliding, to guide and limit the folding lock pin, ensuring that the sliding of the folding lock pin is always in the axial direction.

The present application is further arranged as below: A locking mechanism is provided between two rear wheel brackets, and two ends of the locking mechanism are fixedly connected to the two rear wheel brackets.

According to the technical solution above, after the rear wheel brackets are unfolded, and the two rear wheel brackets are locked and fixed through a locking mechanism so that accidental folding of the rear wheel brackets in the process of using the scooter is avoided and the safety of the scooter during use is enhanced.

The present application is further arranged as below. The second folding mechanism includes a rotation head embedded into the second groove, a first axle hole is formed in a center of the rotation head, the rotation head is movably connected to the second groove by a second pin shaft passing through the first axle hole. A second axle hole and a limiting hole are formed in a lower part of the second groove, the folding lock hole axially parallel to the first axle hole is further provided in the rotation head, a lower end of the folding lock hole is provided with an inward lock hole convex ring, a rolling lock tongue and a spring are successively provided in the folding lock hole. Two limiting holes correspond to positions of a folded rolling lock tongue and an unfolded rolling lock tongue respectively.

According to the technical solution above, in the folding process, as to the second folding mechanism, a smooth rotation is realized through rolling lock tongue, so that the folded scooter is more convenient to store.

The present application is further arranged as below. The locking mechanism includes a first connecting rod, a second connecting rod and a lock connecting buckle. One end of the first connecting rod and one end of the second connecting rod are respectively inserted into and stuck on two sides of the lock connecting buckle, and the lock connecting buckle is provided with a locking switch.

According to the technical solution above, the locking mechanism is simple and reasonable in structure and is convenient to unlock and lock the locking mechanism.

The present application is further arranged as below a locking convex column is provided on each rear wheel bracket, and two locking convex columns are connected to two ends of the locking mechanism.

According to the technical solution above, the locking mechanism is reliably fixed between two rear wheel brackets, so that the rear wheel brackets are locked, and the safety of the scooter during use is guaranteed.

The present application is further arranged as below. Two connecting grooves are respectively formed at one end of the first connecting rod and one end of the second connecting rod. The one end of the first connecting rod is fixed to one rear wheel bracket, and the one end of the second connecting rod is fixed to the other rear wheel bracket. The two connecting grooves correspond to the two locking convex columns.

The present application is further arranged as below. The rolling lock tongue includes a stop block part, a connecting part, and a rolling part. The stop block part, the connecting part, and the rolling part are connected successively, and the rolling part is of a spherical structure.

According to the technical solution above, the rear wheel brackets and the second groove in the frame are fixed and the rolling during locking and folding is realized through the rolling lock tongue and the spring, and thus the folding operations of the rear wheel brackets are simplified.

The present application is further arranged as below. A stop column is further provided in the folding lock hole, and the stop column abuts against one end of the spring.

The present application is further arranged as below. A push rod receiver is provided on a rear part of the saddle, and a push rod is provided in the push rod receiver.

According to the technical solution above, the scooter can be pushed to slide, and entertainment and safety of the scooter are improved.

In brief, the advantages of the present application are that the foldable three-wheeled scooter is easily foldable, compact, safe and reliable.

### BRIEF DESCRIPTION OF THE DRAWINGS

FIG. 1 is a structural schematic diagram of the first embodiment in the present application;

FIG. 2 is a structural schematic diagram of a first folding mechanism of the present application;

FIG. 3 is a structural schematic diagram of a second folding mechanism of the first embodiment of the present application;

FIG. 4 is a structural schematic diagram of a second folding mechanism of the first embodiment of the present application in a locked state;

FIG. 5 is a structural schematic diagram of a second folding mechanism of the first embodiment of the present application in an unlocked state;

FIG. 6 is a structural schematic diagram of a folding lock pin of the first embodiment in the present application;

FIG. 7 is a structural schematic diagram of a lower part of a second groove of the first embodiment in the present application;

FIG. 8 is a structural schematic diagram of the first embodiment of the present application in a folding state;

FIG. 9 is a structural schematic diagram of the first embodiment of the present application with a push rod added.

FIG. 10 is a structural schematic diagram of the second embodiment of the present application;

FIG. 11 is a structural schematic diagram of a locking mechanism of the second embodiment of the present application;

FIG. 12 is a structural schematic diagram of a second folding mechanism of the second embodiment of the present application;

FIG. 13 is sectional view of the second embodiment of the present application in a folding state;

FIG. 14 is a structural schematic diagram of a lower part of a second groove of the second embodiment of the present application;

FIG. 15 is a structural schematic diagram of the second embodiment of the present application in a folding state;

FIG. 16 is a structural schematic diagram of the second embodiment of the present application with a push rod added.

In the drawings, the reference numbers are provided as below.

1. Front fork 11. Handlebar 12. Front wheel bracket 13. Front wheel 14. Folding handle 141. Positioning bump 15. Compression spring 2. Frame 21. Saddle 22. First groove 221. Groove 222. First pin shaft 23. Second groove 231. Lower part of second groove 2311. Axle hole of second groove 2312. Limiting hole 2313. Guiding slot 232. Upper part of second groove 24. Rotation head 241. Axle hole 242. Folding lock hole 2421. Lock hole convex ring 243. Spring 244. Folding lock pin 2441. Unlocking part 2442. Locking part 2443. Guiding part 245. Second pin shaft 246. Rolling lock tongue 2461. Stop block part 2462. Connecting part 2463. Rolling part 247. Stop column 25. Rear wheel bracket 251. Locking convex column 26. Rear wheel 27. Push rod receiver 28. Push rod 29. Locking mechanism 291. First connecting rod 292. Second connecting rod 293. Lock connecting buckle 294. Locking switch 295. Connecting groove

### DETAILED DESCRIPTION OF THE INVENTION

The present application is described in detail, with reference to the accompanying drawings and embodiments. The structural and working principles of the present application are described in detail, with reference to the accompanying drawings.

### Embodiment 1

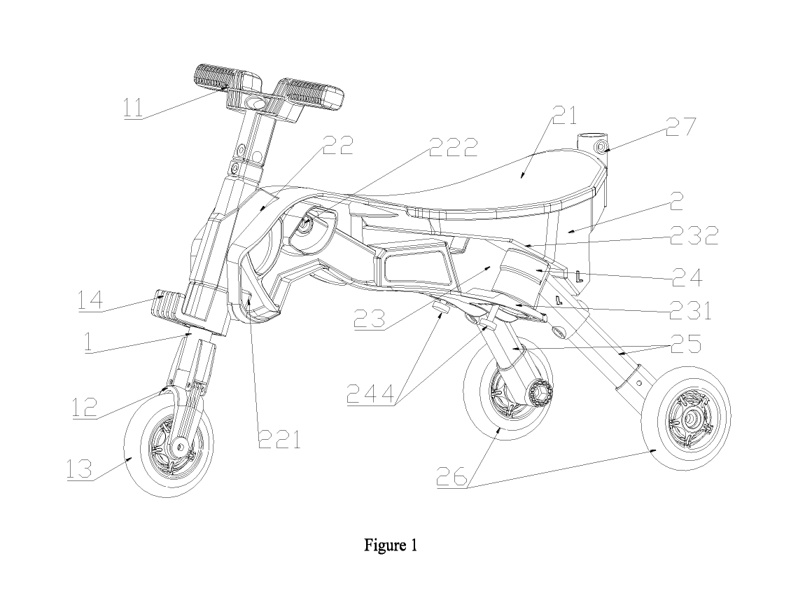

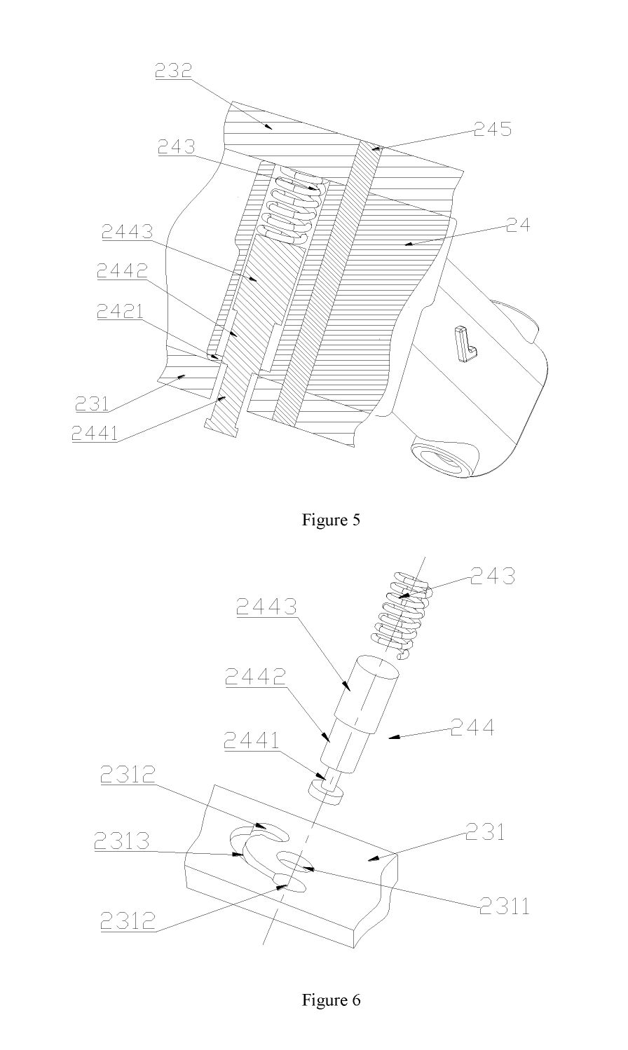

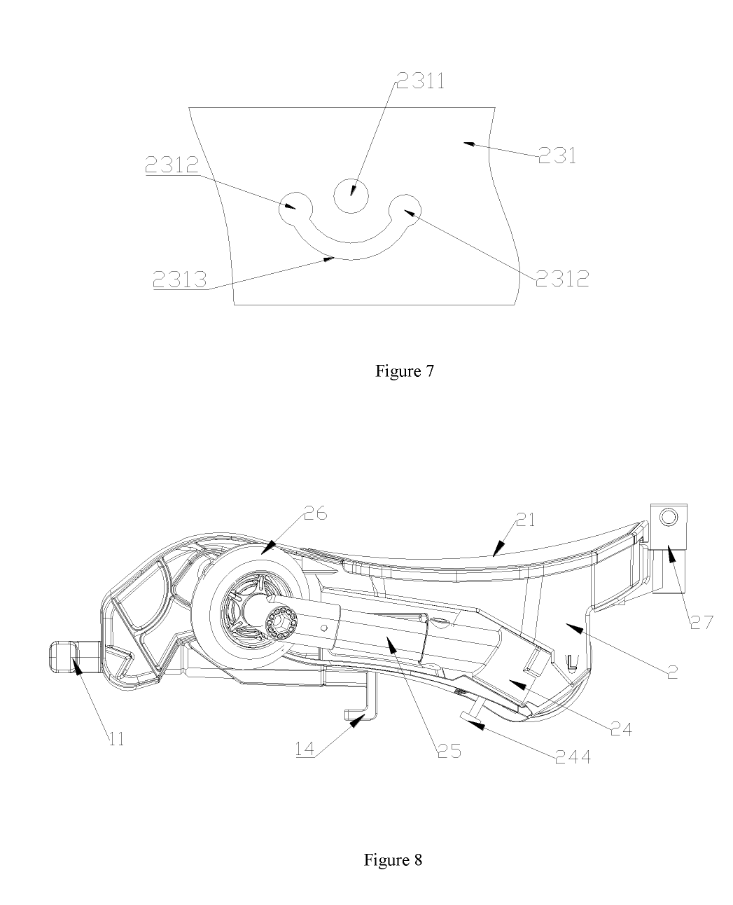

As shown in FIG. 1 to FIG. 9, the foldable three-wheeled scooter of the present application includes front fork 1, frame 2. Handlebar 11 is provided at an upper end of front fork 1. Front wheel 13 is connected to a lower end of front fork 1 by front wheel bracket 12. Saddle 21 is provided on frame 2. Vertical first groove 22 is provided at a front end of frame 2. Horizontal second groove 23 is provided at two sides of the frame 2. Front fork 1 is embedded into first groove 22 and is movably connected to frame 2 by first pin shaft 222. A first folding mechanism is provided in middle of front fork 1. The rear part of second groove 23 is connected to one end of rear wheel bracket 25 by a second folding mechanism. The other end of rear wheel bracket 25 is connected to rear wheels 26.

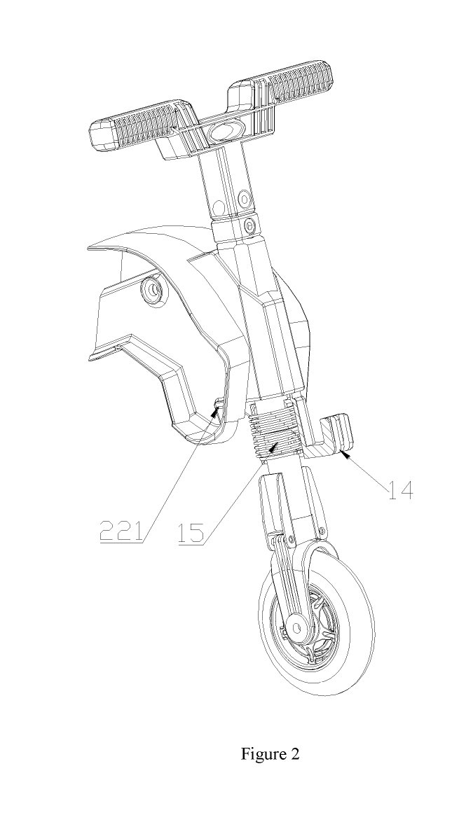

As shown in FIG. 2, the first folding mechanism includes compression spring 15 and folding handle 14 successively sleeved on the middle of front fork 1. Positioning bump 141 is provided on the upper part of folding handle 14 and is closed to frame 2. Groove 221, corresponding to positioning bump 141, is provided on frame 2.

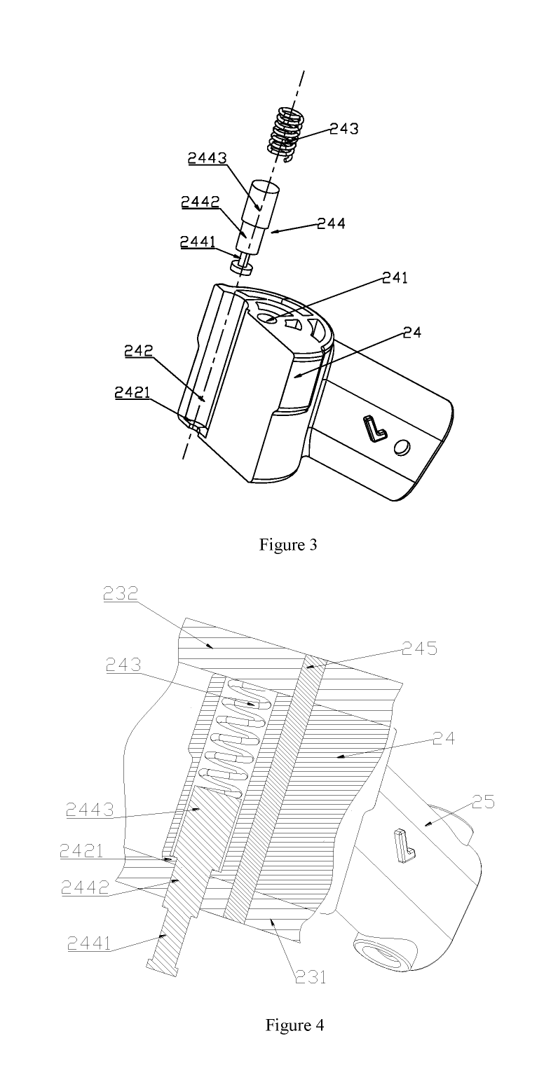

As shown in FIGS. 3-7, the second folding mechanism includes rotation head 24 embedded in second groove 23. Axle hole 241 is provided in middle of rotation head 24. Rotation head 24 is movably connected to second groove 23 by second pin shaft 245 through axle hole 241. Axle hole 2311 of second groove 23 and an arc-shaped through hole are provided in lower part 231 of second groove 23. The arc-shaped through hole includes an arc-shaped guide slot 2313. Two ends of guide slot 2313 are respectively connected to two limiting holes of the same size. Folding lock hole 242 axially parallel to axle hole 241 is provided in rotation head 24. Convex ring 2421 extending inward is provided at a lower end of folding lock hole 242. Folding lock pin 244 and spring 243 are successively provided in folding lock hole 242. Folding lock pin 244 goes through the arc-shaped through hole.

Guiding slot 2313 is concentric with axle hole 2311 of second groove 23.

Folding lock pin 244 includes unlocking part 2441, locking part 2442 and guiding part 2443. Guiding part 2443 corresponds to folding lock hole 242, locking part 2442 corresponds to limiting hole 2312, and unlocking part 2441 corresponds to guiding slot 2313.

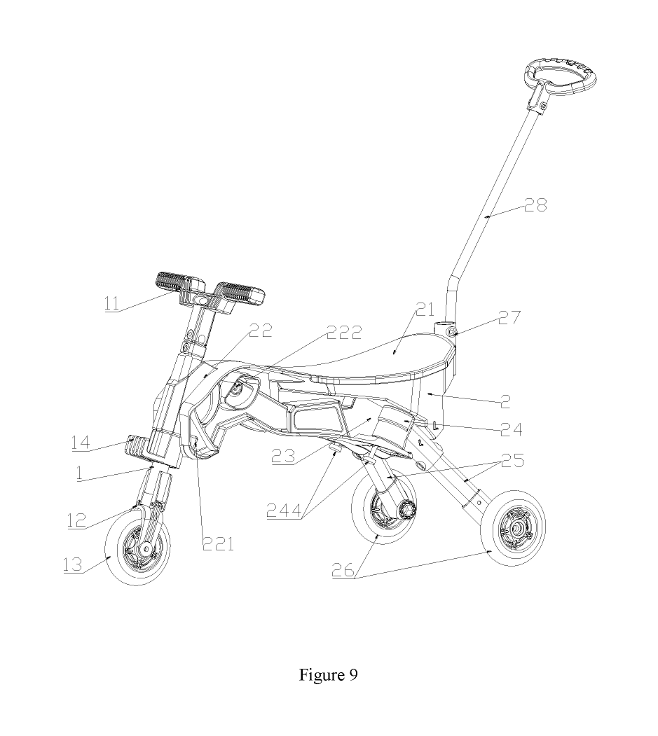

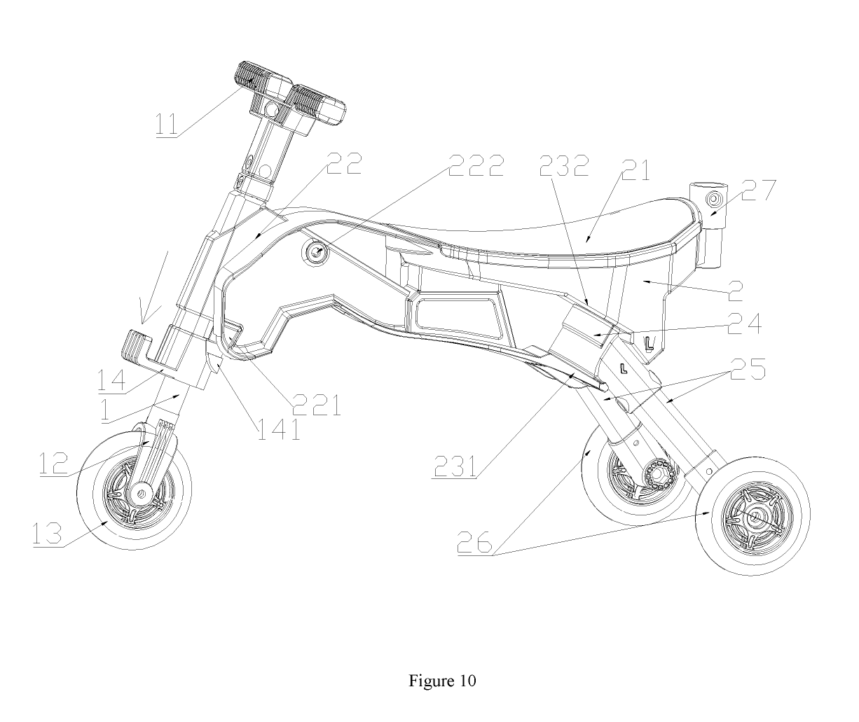

As shown in FIG. 9, push rod receiver 27 is further arranged at the rear part of saddle 21, and is used for installing push rod 28. Push rod 28 is configured for pushing the scooter to move from the back conveniently.

The working principle of the embodiment 1 is provided as below. In a normal moving state, for front fork 1, under the action of compression spring 15, positioning bump 141 on folding handle 14 is snapped into groove 221, so that front fork 1 is stably locked with frame 2 without any movement.

As shown in FIG. 8, if front wheel 13 is needed to be folded, folding handle 14 is firstly pulled downward to overcome the elastic force of compression spring 15 so that positioning bump 141 is detached from groove 221. Simultaneously, front wheel 13 is also pushed backward hard so that the whole front fork 1 rotates counterclockwise around first pin shaft 222. Front fork 1 is finally folded under frame 2.

Similarly, if front wheel 13 is to be restored, front wheel 13 is required to be pulled downward and forward, so that front fork 1 rotates clockwise around first pin shaft 222. When folding handle 14 moves to the lower end of first groove 22 in frame 2, the lower end of first groove 22 presses folding handle 14 downward. When front wheel 13 is pulled forward to the limit, folding handle 14 bounces back and positioning bump 141 is snapped into groove 221. The whole process of restoring front wheel 13 is done.

Rotation head 24 is embedded between upper part 232 of second groove 23 and lower part 231 of second groove 23. Rotation head 24 is movably connected to second groove 23 by second pin shaft 245. When rear wheels 26 are in a normal moving state, lock part 2442 of folding lock pin 244 is inserted into limiting hole 2312. Since the slot width of guiding slot 2313 is smaller than the diameter of limiting hole 2312, so rotation head 24 is stably locked in second groove 23 without any movement.

If rear wheels 26 are needed to be folded, folding lock pin 244 is required to be unlocked firstly. Folding lock pin 244 is pushed upward until locking part 2442 is pushed out of limiting hole 2312. Rear wheels 26 are pulled outward and forward simultaneously so that rotation head 24 rotates around second pin shaft 245 and unlocking part 2441 slides along arc-shaped guiding slot 2313. When unlocking part 2441 slides to limiting hole 2312 connected to the other end of guiding slot 2313, under the action of spring 243, locking part 2442 is inserted into limiting hole 2312 and rotation head 24 is locked. At this point, rear wheels 26 are folded on two sides of frame 2.

Similarly, if real wheels 26 are to be restored, opposite operations to the operations for folding rear wheels 26 are performed.

### Embodiment 2

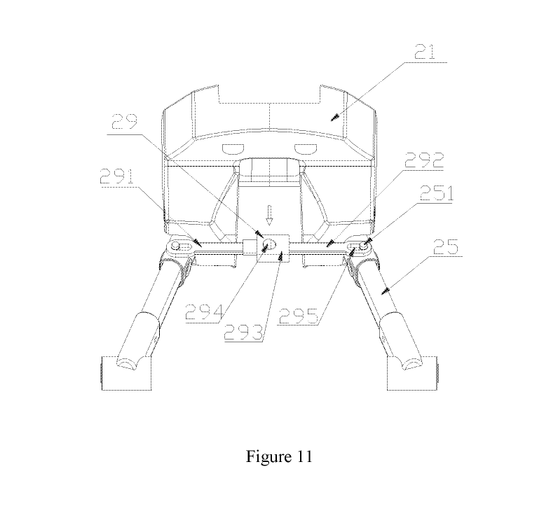

The differences between the second embodiment and the first embodiment are as below: As shown in FIG. 11, locking mechanism 29 is arranged between two rear wheel brackets 25, and two ends of the locking mechanism 29 are respectively and fixedly connected to two rear wheel brackets 25.

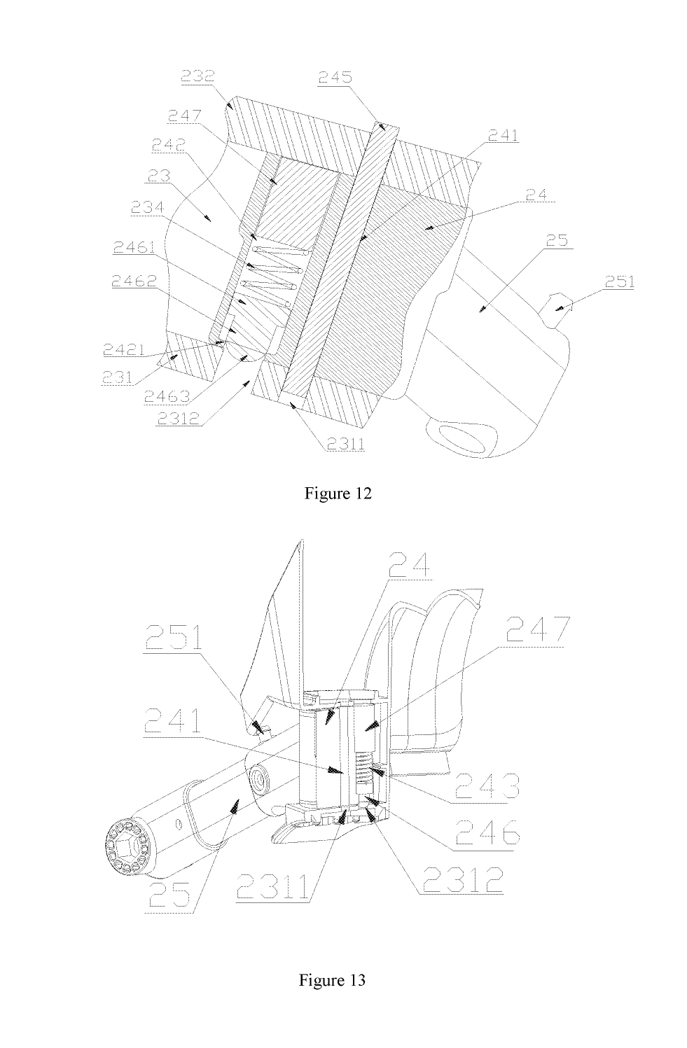

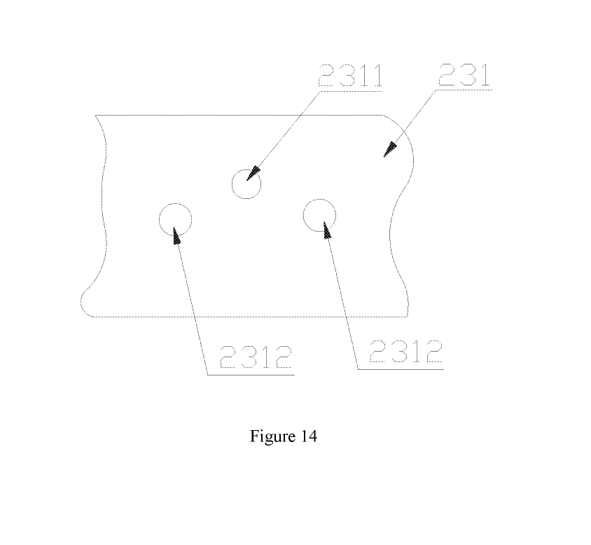

As shown in FIG. 12-FIG. 14, the second folding mechanism includes rotation head 24 embedded into second groove 23. Axle hole 241 is formed in the center of rotation head 24. Rotation head 24 is movably connected to second groove 23 by second pin shaft 245 passing through axle hole 241. Axle hole 2311 of second groove and limiting hole 2312 are formed in the lower part of second groove 23. Folding lock hole 242 axially parallel to axle hole 241 is further provided in rotation head 24. The lower end of folding lock hole 242 is provided with an inward lock hole convex ring 2421. Rolling lock tongue 246 and spring 243 are arranged in folding lock hole 242 in sequence. Two limiting holes 2312 correspond to the positions of the folded rolling lock tongue 246 and unfolded rolling lock tongue 246 respectively. Stop column 247 is further arranged in folding lock hole 242, and one end of stop column 247 abuts against one end of the spring 243, and the other end of stop column 247 abuts against the upper part 232 of the second groove to fix the spring 243.

Preferably, the rolling lock tongue 246 includes stop block part 2461, connecting part 2462 and a rolling part 2463 which are connected in sequence. Rolling part 2463 is of a spherical structure. Similar to the structure of ball pen head, rolling part 2463 can roll in connecting part 2462 and would not slip out from connecting part 2462. Meanwhile, the diameter of rolling part 2463 is larger than that of limiting hole 2312, so that a part of the structure of the rolling part 2463 which is smaller than the radius height can be stuck in limiting hole 2312, and cannot slip out of limiting hole 2312. In the folding state, rolling part 2463 is stuck in limiting hole 2412 on one side. When the scooter needs to be unfolded, rear wheel brackets 25 can be directly pulled and the rolling lock tongue 246 is lifted upwards due to the action of spring 243. Rolling part 2463 is separated from limiting hole 2312, and rear wheel brackets 25 rotate around second pin shaft 245. When the position of the fully unfolded state is reached, rolling lock tongue 246 is stuck in limiting hole 2412 on the other side again, to fix the position of rear wheel bracket 25.

The two ends of locking mechanism 29 are respectively and fixedly connected to two rear wheel brackets 25. Preferably, locking mechanism 29 includes first connecting rod 291, second connecting rod 292 and lock connecting buckle 293. One end of first connecting rod 291 and one end of second connecting rod 292 are respectively inserted into and stuck on the two sides of lock connecting buckle 293. Locking convex column 251 is arranged on each rear wheel bracket 25, and the locking convex columns 251 are connected to the two ends of locking mechanism 29. Two Connecting grooves 295 are respectively formed at one end of first connecting rod 291 which is fixed to one rear wheel bracket 25, and at one end of second connecting rod 292 which is fixed to the other rear wheel bracket 25. Connecting grooves 295 correspond to locking convex columns 251. Lock connecting buckle 293 is provided with locking switch 294. One end of first connecting rod 291 and one end of second connecting rod 292 are stuck in lock connecting buckle 293 through a buckle and a spring. If locking switch 294 is pressed down, the buckle is separated from locking connection buckle 293, so that first connecting rod 291 and second connecting rod 292 can be pulled out of lock connecting buckle 293 respectively.

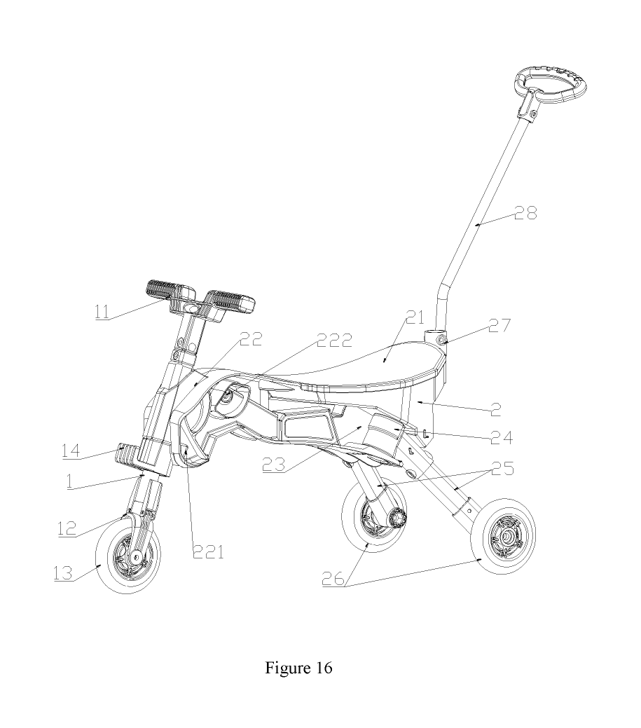

As shown in FIG. 16, push rod receiver 27 is further arranged at the rear part of saddle 21, and is used for installing push rod 28. Push rod 28 is configured for pushing the scooter to move from the back conveniently.

The working principle of the second embodiment is provided as below: When front fork 1 runs normally, as to folding handle 14, positioning convex block 141 is snapped into groove 221 under the action of compression spring 15, so that front fork 1 and frame 2 are firmly locked without movement.

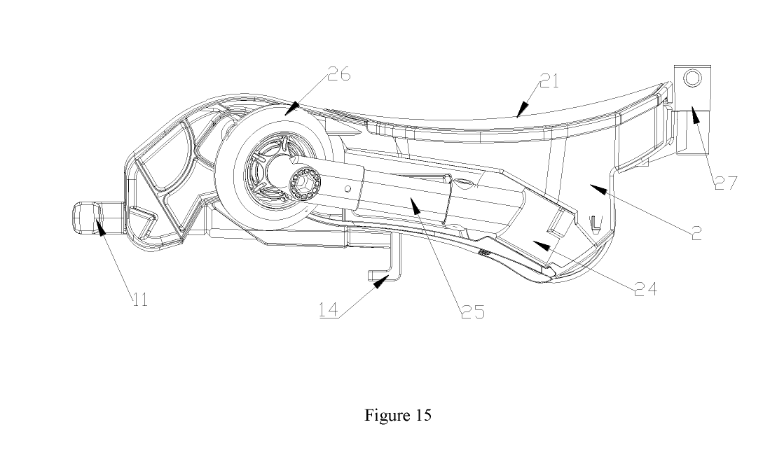

As shown in FIG. 15, when front wheel 13 needs to be folded, folding handle 14 is firstly pulled downwards to overcome the elastic force of compression spring 15, so that positioning bump 141 is separated from groove 221. Meanwhile, front wheel 13 is pushed backwards hard, so that the whole front fork 1 rotates counterclockwise around the first pin shaft 222. Finally, front fork 1 is folded under frame 2.

Similarly, if front wheel 13 is to be restored, front wheel 13 is required to be pulled downward and forward, so that front fork 1 rotates clockwise around first pin shaft 222. When folding handle 14 moves to the lower end of first groove 22 in frame 2, the lower end of first groove 22 presses folding handle 14 downward. When front wheel 13 is pulled forward to the limit, folding handle 14 bounces back and positioning bump 141 is snapped into groove 221. The whole process of restoring front wheel 13 is done.

Rotation head 24 is embedded between the upper part 232 of the second groove and the lower part 231 of the second groove and is movably connected to second groove 23 through second pin shaft 245. When rear wheel 26 runs normally, rolling part 2463 of rolling lock tongue 246 is inserted into limiting hole 2312 of the unfolding position and is stuck in limiting hole 2312 under the action of spring 243, so that rotation head 24 is fixed in second groove 23. At the same time, one end of first connecting rod 291 where connecting groove 295 is located, is fixed to locking convex column 251 of one rear wheel bracket 26. One end of second connecting rod 292 where the other connecting groove 295 is located, is fixed to locking convex column 251 of the other rear wheel bracket 26. The other end of first connecting rod 291 and the other end of second connecting rod 292 are respectively inserted into and fixed in lock connecting buckle 293, so that rear wheel brackets 26 can be further reliably locked and fixed.

When the rear wheels 26 need to be folded, locking switch 294 on lock connecting buckle 293 is pressed, first connecting rod 291 and second connecting rod 292 are separated from lock connecting buckle 293 to unlock rear wheel brackets 26. Rear wheel brackets 25 are then pulled, because rolling part 2463 fixed to the end of rolling lock tongue 246 is in a ball shape, an extrusion force is exerted on spring 243 by pulling rear wheel brackets 25, and rolling part 2463 can thus roll out of the groove of limiting hole 2312. Meanwhile, rear wheels 26 are pulled outwards and forwards, and the rotation head 24 rotates around the second pin shaft 245, rolling part 2463 can roll on the inner wall of the lower part 231 of the second groove. When rolling to the limiting hole 2312 of the folding position, under the action of spring 243, rolling part 2463 is sunken into and stuck in limiting hole 2312, and rotation head 24 is then locked. Thus, rear wheels 26 are folded on the side edge of frame 2.

Similarly, if real wheels 26 are to be restored, opposite operations to the operations for folding rear wheels 26 are performed.

The present application also certainly has other various embodiments. Without departing from the spirit and nature of the present application, various corresponding modifications and variations can be made to the present application by the skilled in the art. However, these corresponding modifications and variations all fall within the protection scope of the appended claims of the present application.

What is claimed is:

1. A foldable three-wheeled scooter, comprising:
a front fork; and
a frame,
wherein a handlebar is provided at an upper end of the front fork, a front wheel is connected to a lower end of the front fork by a front wheel bracket, and a saddle is provided on the frame,
wherein a vertical first groove is provided at a front end of the frame, a horizontal second groove is provided at two sides of the frame, the front fork is embedded into a first groove and is movably connected to the frame by a first pin shaft, a first folding mechanism is provided in the middle of the front fork, a rear part of the second groove is connected to one end of a rear wheel bracket by a second folding mechanism, and the other end of the rear wheel bracket is connected to a rear wheel.

2. The foldable three-wheeled scooter of claim 1, wherein the first folding mechanism includes a compression spring and a folding handle successively sleeved on the middle of the front fork, a positioning bump is provided on an upper part of the folding handle and is closed to the frame, a groove corresponding to the positioning bump is provided on the frame.

3. The foldable three-wheeled scooter of claim 1, wherein the second folding mechanism includes a rotation head embedded in the second groove, a first axle hole is provided in the middle of the rotation head, the rotation head is movably connected to the second groove by a second pin shaft through the first axle hole, a second axle hole and an arc-shaped through hole are provided in a lower part of the second groove, the arc-shaped through hole includes an arc-shaped guiding slot, two ends of the guiding slot are respectively connected to two limiting holes of the same size; a folding lock hole axially parallel to the first axle hole is provided in the rotation head, an inward lock hole convex ring is provided at a lower end of the folding lock hole, a folding lock pin and a spring are successively provided in the folding lock hole, and the folding lock pin goes through the arc-shaped through hole.

4. The foldable three-wheeled scooter of claim 3, wherein the guiding slot is concentric with the second axle hole of the second groove.

5. The foldable three-wheeled scooter of claim 3, wherein the folding lock pin includes an unlocking part, a locking part, and a guiding part, which have successively increased diameters.

6. The foldable three-wheeled scooter of claim 5, wherein the guiding part corresponds to the folding lock hole, the locking part corresponds to the limiting holes, and the unlocking part corresponds to the guiding slot.

7. The foldable three-wheeled scooter of claim 1, wherein a locking mechanism is provided between two rear wheel brackets, and two ends of the locking mechanism are respectively and fixedly connected to the two rear wheel brackets.

8. The foldable three-wheeled scooter of claim 1, wherein the second folding mechanism includes a rotation head embedded into the second groove, a first axle hole is formed in a center of the rotation head, the rotation head is movably connected to the second groove by a second pin shaft passing through the first axle hole,
wherein a second axle hole and a limiting hole are formed in a lower part of the second groove, the folding lock hole axially parallel to the first axle hole is provided in the rotation head, a lower end of the folding lock hole is provided with an inward lock hole convex ring, a rolling lock tongue and a spring are successively provided in the folding lock hole,
wherein two limiting holes correspond to positions of a folded rolling lock tongue and an unfolded rolling lock tongue respectively.

9. The foldable three-wheeled scooter of claim 7, wherein the locking mechanism includes a first connecting rod, a second connecting rod and a lock connecting buckle, one end of the first connecting rod and one end of the second connecting rod are respectively inserted into and stuck on two sides of the lock connecting buckle, and the lock connecting buckle is provided with a locking switch.

10. The foldable three-wheeled scooter of claim 7, a locking convex column is provided on each rear wheel bracket, and two locking convex columns are connected to two ends of the locking mechanism.

11. The foldable three-wheeled scooter of claim 9, wherein two connecting grooves are respectively formed at one end of the first connecting rod and one end of the second connecting rod, wherein the one end of the first connecting rod is fixed to one rear wheel bracket, and the one end of the second connecting rod is fixed to the other rear wheel bracket, wherein the two connecting grooves correspond to the two locking convex columns.

12. The foldable three-wheeled scooter of claim 8, wherein the rolling lock tongue includes a stop block part, a connecting part, and a rolling part, wherein the stop block part, the connecting part and the rolling part are connected successively, and the rolling part is of a spherical structure.

13. The foldable three-wheeled scooter of claim 8, wherein a stop column is provided in the folding lock hole, and the stop column abuts against one end of the spring.

14. The foldable three-wheeled scooter of claim 1, wherein a push rod receiver is provided on a rear part of the saddle, and a push rod is provided in the push rod receiver.

15. The foldable three-wheeled scooter of claim 7, wherein the second folding mechanism includes a rotation head embedded into the second groove, a first axle hole is formed in a center of the rotation head, the rotation head is movably connected to the second groove by a second pin shaft passing through the first axle hole,
wherein a second axle hole and a limiting hole are formed in a lower part of the second groove, the folding lock hole axially parallel to the first axle hole is further provided in the rotation head, a lower end of the folding lock hole is provided with an inward lock hole convex ring, a rolling lock tongue and a spring are successively provided in the folding lock hole,
wherein two limiting holes correspond to positions of a folded rolling lock tongue and an unfolded rolling lock tongue respectively.

16. The foldable three-wheeled scooter of claim 15, wherein the rolling lock tongue includes a stop block part, a connecting part, and a rolling part, wherein the stop block part, the connecting part and the rolling part are connected successively, and the rolling part is of a spherical structure.

17. The foldable three-wheeled scooter of claim 15, wherein a stop column is provided in the folding lock hole, and the stop column abuts against one end of the spring.
